(19) United States
(12) Patent Application Publication
(10) Pub. No.: US 2013/0038130 A1
(43) Pub. Date: Feb. 14, 2013

(54) DC-TO-AC CONVERTER SYSTEM AND DC-TO-AC CONVERTER CIRCUIT

(71) Applicant: CHING-MING LAI, TAIPEI (TW)

(72) Inventor: CHING-MING LAI, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/400,771

(22) Filed: Feb. 21, 2012

(30) Foreign Application Priority Data
Aug. 12, 2011 (CN) 201110234334.1

(51) Int. Cl. H02J 1/00

(52) U.S. Cl. 307/80

(57) ABSTRACT

A DC-to-AC converter circuit includes a step-up converter module and an inverter module. The step-up module includes first and second inductors that cooperate to form a transformer, first and second power switches, and first and second capacitors. When the first power switch and the second power switch conduct, the first inductor and the second inductor store energy from a first variable power source and a second variable power source respectively, and after the first capacitor and the second capacitor provide electrical energy to the inverter module, the inverter module converts the electrical energy provided thereto and outputs converted energy.

### CROSS-REFERENCE TO RELATED APPLICATION

This application claims priority to Chinese Patent Application No. 201110234334.1, filed on Aug. 12, 2011.

### BACKGROUND OF THE INVENTION

1. Field of the Invention

The invention relates to a converter circuit, and more particularly to a direct current to alternating current converter (DC-to-AC converter) circuit.

2. Description of the Related Art

Because of the relationship with geographical location and climate, solar energy and wind energy power generation technologies are the most mature and the most utilized distributed power generating methods in Taiwan. However, as solar energy and wind energy are easily affected by seasonal changes, the power generating efficiency is unstable. To maximize the efficiency of power generation, there have been suggested many converter systems that integrate both solar energy and wind energy. Such systems are expected to use fewer components to improve upon the disadvantage of unstable power generation in single distributed power generating systems, and feed the power generated by these distributed power generating methods to a commercial power grid.

Current converter systems that integrate photo voltaic/wind power as energy sources can be categorized into parallel AC terminal type, parallel DC terminal type, and an input integrated type.

However, efficiency-wise, the DC-to-AC converters nowadays are mostly two stage energy converter systems. Overall, the power generated efficiency of such systems is somewhat poor and is not considered adequate for extracting and using reusable/green energy. Moreover, in view of the need for stability during operation, different controllers to control different circuit stages are currently adopted, which increases costs. Furthermore, when the power capacity of the system is to be increased, more converters are needed whether they are parallel integrated or series integrated, and processors for controlling the power distribution and balance are also needed, which increases the complexity of the circuit design.

### SUMMARY OF THE INVENTION

Therefore, an object of the present invention is to provide a DC-to-AC converter that can reduce component costs, increase stability and increase energy conversion efficiency.

The DC-to-AC converter circuit of the present invention includes a step-up converter module and an inverter module.

The step-up converter module includes a first inductor, a second inductor, a first power switch, a second power switch, a first capacitor and a second capacitor. The first inductor has a first terminal for receiving signal of a first variable power source, and a second terminal. The first power switch is electrically coupled to the second terminal of the first inductor. The first capacitor has a first terminal electrically coupled to the second terminal of the first inductor, and a second terminal. The second inductor cooperates with the first inductor to form a transformer. The second inductor has a first terminal for receiving a second variable power source, and a second terminal. The second power switch is electrically coupled to the second terminal of the second inductor. The second capacitor has a first terminal electrically coupled to the second terminal of the second inductor, and a second terminal.

The inverter module is electrically coupled to the second terminal of the first capacitor and the second terminal of the second capacitor.

When the first power switch and the second power switch conduct, the first inductor and the second inductor store energy from the first variable power source and the second variable power source respectively. After the first capacitor and the second capacitor provide electrical energy to the inverter module, the inverter module converts the electrical energy provided thereto and outputs converted energy to maximise power tracking, extracting maximum energy, and providing a low harmonic power output to increase the power quality given to users/clients. When the first power switch is not conducting, the first capacitor receives energy from the first variable power source and the first inductor, and when the second power switch is not conducting, the second capacitor receives energy from the second variable power source and the second inductor. As the DC-to-AC converter circuit of the present embodiment employs the step-up converter module and the inverter module and has a specially designed pulse-width modulation integrated into a single-stage power conversion circuit, characteristics of multiple inputs, DC-to-AC system integration, common power switches, step-up/step-down and low switch voltage may be achieved.

The step-up converter module can further include a third inductor, a fourth inductor, a third power switch and a fourth power switch.

The third inductor has a first terminal for receiving signal of a third variable power source, and a second terminal. The third power switch is electrically coupled to the second terminal of the third inductor and the first terminal of the first capacitor. The fourth inductor has a first terminal for receiving signal of a fourth variable power source, and a second terminal. The first, second, third and fourth inductors cooperate to form a transformer. The fourth power switch is electrically coupled to the second terminal of the fourth inductor and the first terminal of the second capacitor. When third and fourth power switches conduct, the third and fourth inductors store energy from the third and fourth variable power sources respectively. After the first capacitor and the second capacitor provide electrical energy to the inverter module, the inverter module converts the electrical energy provided thereto and outputs converted energy. When the third power switch is not conducting, the first capacitor receives electrical energy from the third variable power source and the third inductor, and when the fourth power switch is not conducting, the second capacitor receives electrical energy from the fourth variable power source and the fourth inductor.

Another object of the present invention is to provide a DC-to-AC converter system using the DC-to-AC converter circuit described above, wherein the system includes the aforesaid DC-to-AC converter circuit and a controller that controls conduction and non-conduction of the first to fourth power switches of the DC-to-AC converter circuit.

The advantages of the present invention reside in:
1. providing multiple low-voltage/high current inputs and maximising power tracking according to energy source demand to extract maximum energy.
2. providing a low harmonic power output to increase the power quality given to users/clients.
3. enabling each power switch of the power converter on the AC-side to have low switch voltage stress such that the system has higher reliability and higher energy conversion efficiency.
4. having integrated single-stage power conversion and single system controller structure that can reduce the cost.
5. having bidirectional power flow capability to provide multiple outputs of different voltages when used as a rectifier.
6. having the design of the first inductor cooperating with the second inductor to form a transformer, the third inductor cooperating with the fourth inductor to form a transformer, and allowing multiple inductor groups and their corresponding power switches to share the first and second capacitors that can reduce the number of components and further reduce the cost.

### BRIEF DESCRIPTION OF THE DRAWINGS

Other features and advantages of the present invention will become apparent in the following detailed description of the preferred embodiments with reference to the accompanying drawings, of which:

FIG. 1 illustrates the first embodiment of a DC-to-AC converter system of the present invention;

FIG. 2 is a circuit diagram of a DC-to-AC converter circuit in the first embodiment of the present invention;

FIG. 3 illustrates current directions of a first loop, a second loop, and energy release of two capacitors when first and second power switches of the DC-to-AC converter circuit in the first embodiment are both conducting;

FIG. 4 illustrates current directions of the first loop, the second loop, and energy release of the two capacitors when the first power switch is not conducting while the second power switch is conducting;

FIG. 5 illustrates the current directions of the first loop, the second loop, and energy release of the two capacitors when the first power switch is conducting while the second power switch is not conducting;

FIG. 6 illustrates the current directions of a third loop, a fourth loop, and output circulating current when the first and second power switches are both not conducting;

FIG. 7 is a wave diagram illustrating the neutral-point voltage, the output voltage, and the output current of the inverter module in the first embodiment of the present invention;

FIG. 8 illustrates the second embodiment of the DC-to-AC converter system of the present invention;

FIG. 9 illustrates the third embodiment of the DC-to-AC converter system of the present invention; and

FIG. 10 illustrates a modification of the third embodiment of the DC-to-AC converter system of the present invention.

### DETAILED DESCRIPTION OF THE PREFERRED EMBODIMENTS

Before the present invention is described in greater detail, it should be noted that like elements are denoted by the same reference numerals throughout the disclosure.

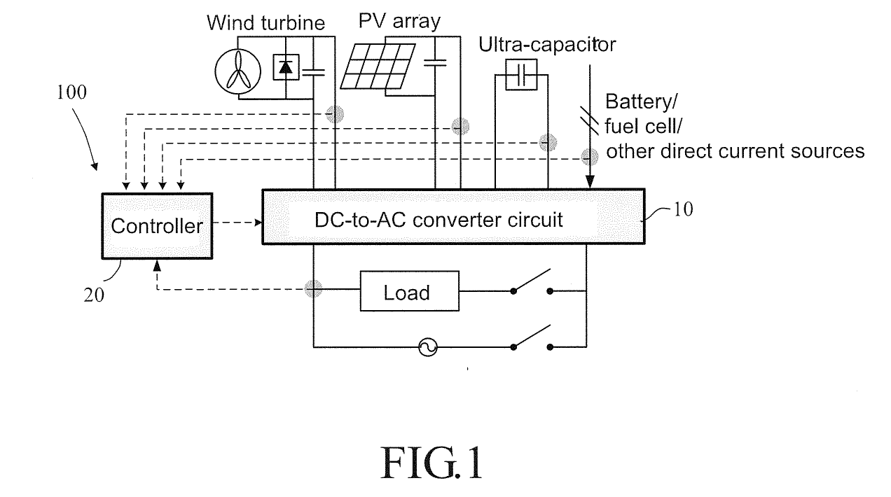

FIG. 1 shows the first embodiment of a DC-to-AC converter system 100 of the present invention. The DC-to-AC converter system 100 includes an integrated DC-to-AC converter circuit 10 and a controller 20. The DC-to-AC converter circuit 10 is to receive reusable/green energy from resources such as a PV array, a wind turbine, a battery, a fuel cell, an ultra-capacitor, etc. The controller 20 controls the DC-to-AC converter circuit 10 to boost and convert signals from these energy resources to obtain an output supply voltage of low harmonic high electric power quality.

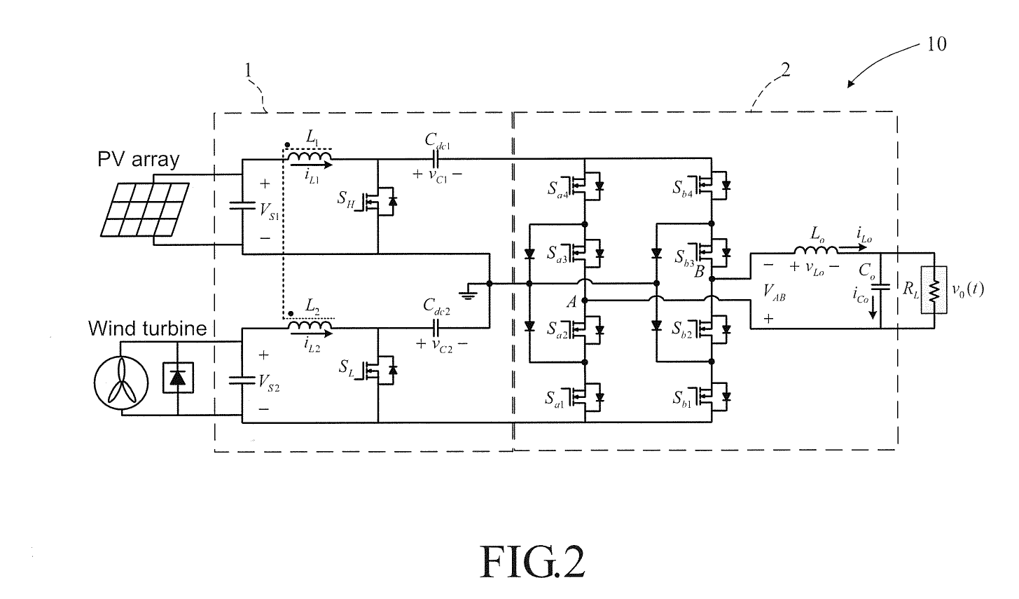

Referring to FIG. 2, the DC-to-AC converter circuit 10 includes a step-up converter module 1 and an inverter module 2. The step-up converter module 1 includes a first inductor L₁, a second inductor L₂, a first power switch S_{H}, a second power switch S_{L}, a first capacitor C_{dc1} and a second capacitor C_{dc2} wherein the first inductor L₁ cooperates with the first power switch S_{H} to form a first step-up converter unit, and the second inductor L₂ cooperates with the second power switch S_{L} to form a second step-up converter unit.

The first inductor L₁ has a first terminal to be receiving signal of a first variable power source V_{S1}, and a second terminal. PV array is used here as the example of the first variable power source V_{S1}. The first power switch S_{H} is an N-type metal oxide semiconductor-field effect transistor having a drain (D) electrically coupled to the second terminal of the first inductor L₁, a gate (G) electrically coupled to the controller 20, and a source (S). The controller 20 controls the first power switch S_{H}, to be in a conducting state (ON) or a non-conducting state (OFF). The first capacitor C_{dc1} has a first terminal electrically coupled to the second terminal of the first inductor L₁ and the drain (D) of the first power switch S_{H}, and a second terminal.

The second inductor L₂ cooperates with the first inductor L₁ to form a transformer. The second inductor L₂ has a first terminal to receive a second variable power source V_{S2}, and a second terminal. Wind turbine is used here as the example of the second variable power source V_{S2}. The second power switch S_{L} is an N-type metal oxide semiconductor-field effect transistor having a drain (D) electrically coupled to the second terminal of the second inductor L₂, agate (G) electrically coupled to the controller 20, and a source (S). The controller 20 controls the second power switch S_{L} to be in the conducting state (ON) or the non-conducting state (OFF). The second capacitor C_{dc2} has a first terminal electrically coupled to the second terminal of the second inductor L₂ and the drain (D) of the second power switch S_{L}, and a second terminal electrically coupled to the source (S) of the first power switch S_{H}.

The inverter module 2 is a neutral-point clamping inverter having a first switch Sₐ₁, a second switch Sₐ₂, a third switch Sₐ₃, a fourth switch Sₐ₄, a fifth switch S_{b1}, a sixth switch S_{b2}, a seventh switch S_{b3}, an eighth switch S_{b4}, an output inductor L_{O}, and an output capacitor C_{O}.

The first to fourth switches Sₐ₁-Sₐ₄ are all N-type metal oxide semiconductor-field effect transistors. The drain (D) of the first switch Sₐ₁ is electrically coupled to the source (S) of the second switch Sₐ₂. The drain (D) of the second switch Sₐ₂ is electrically coupled to the source (S) of the third switch Sₐ₃. The drain (D) of the third switch Sₐ₃ is electrically coupled to the source (S) of the fourth switch Sₐ₄. The source (S) of the first switch Sₐ₁ is electrically coupled to the source (S) of the second power switch S_{L}. The drain (D) of the fourth switch Sₐ₄ is electrically coupled to the second terminal of the first capacitor C_{dc1}. The gates (G) of the first to fourth switches Sₐ₁-Sₐ₄ are electrically coupled to the controller 20 and the first to fourth switches Sₐ₁-Sₐ₄ are controlled by the controller 20 to be in the conducting state (ON) or non-conducting state (OFF).

The fifth to eighth switches S_{b1}-S_{b4} are all N-type metal oxide semiconductor-field effect transistors and are all controlled by the controller 20 to be in the conducting state (ON) or non-conducting state (OFF). The drain (D) of the fifth switch S_{b1} is electrically coupled to the source (S) of the sixth switch Sₐ₂. The drain (D) of the sixth switch Sₐ₂ is electrically coupled to the source (S) of the seventh switch S_{b3}. The drain (D) of the seventh switch S_{b3} is electrically coupled to the source (S) of the eighth switch S_{b4}. The source (S) of the fifth switch S_{b1} is electrically coupled to the source (S) of the second power switch S_{L}. the drain (D) of the eighth switch S_{b4} is electrically coupled to the second terminal of the first capacitor C_{dc1}. In the present embodiment, the source (S) of the first power switch S_{H}, the second terminal of the second capacitor C_{dc2}, the drain (D) of the first switch Sₐ₁, the drain (D) of the third switch Sₐ₃, the drain (D) of the fifth switch S_{b1}, and the drain (D) of the seventh switch S_{b3} are electrically coupled to ground.

The output inductor L_{O} has a first terminal electrically coupled to the drain (D) of the sixth switch S_{b2} (node B in the figures), and a second terminal electrically coupled to a first terminal of the output capacitor C_{O} and a load R_{L}. The output capacitor C_{O} has a second terminal electrically coupled to the drain (D) of the second switch Sₐ₂ (node A in the figures).

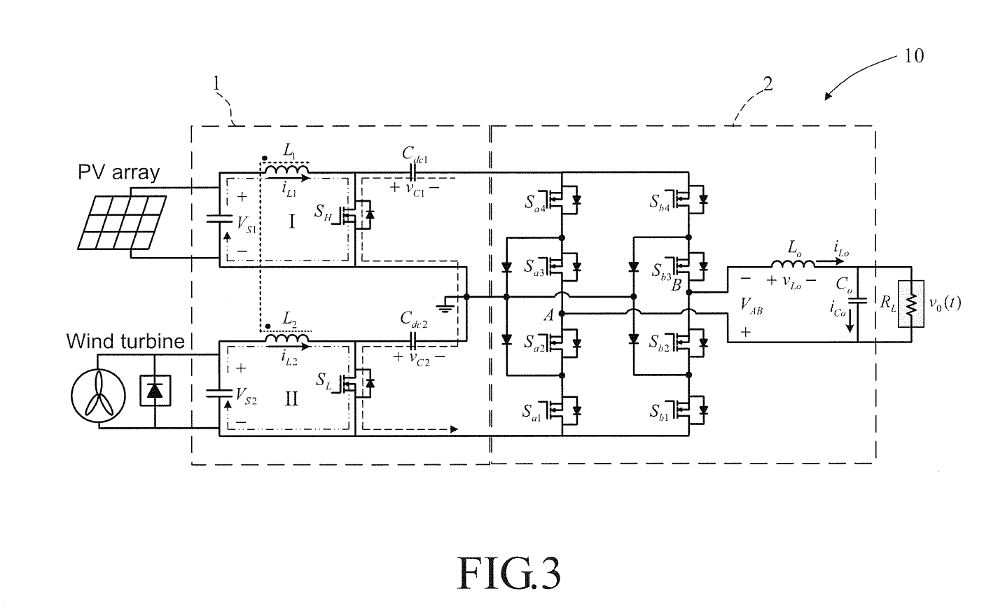

Referring to FIG. 3, when the controller 20 controls the first and second power switches S_{H}, S_{L} to conduct, the first variable power source V_{S1} and the first inductor L₁ form a first loop I, and the second variable power source V_{S2} and the second inductor L₂ form a second loop II. The first inductor L₁ and the second inductor L₂ store energy of the first variable power source V_{S1} and the second variable power source V_{S2} respectively. After the first capacitor C_{dc1} and the second capacitor C_{dc2} are series-connected to provide additive electrical energy thereof to the inverter module 2, the inverter module 2 converts the electrical energy provided thereto and outputs converted energy to the load R_{L}.

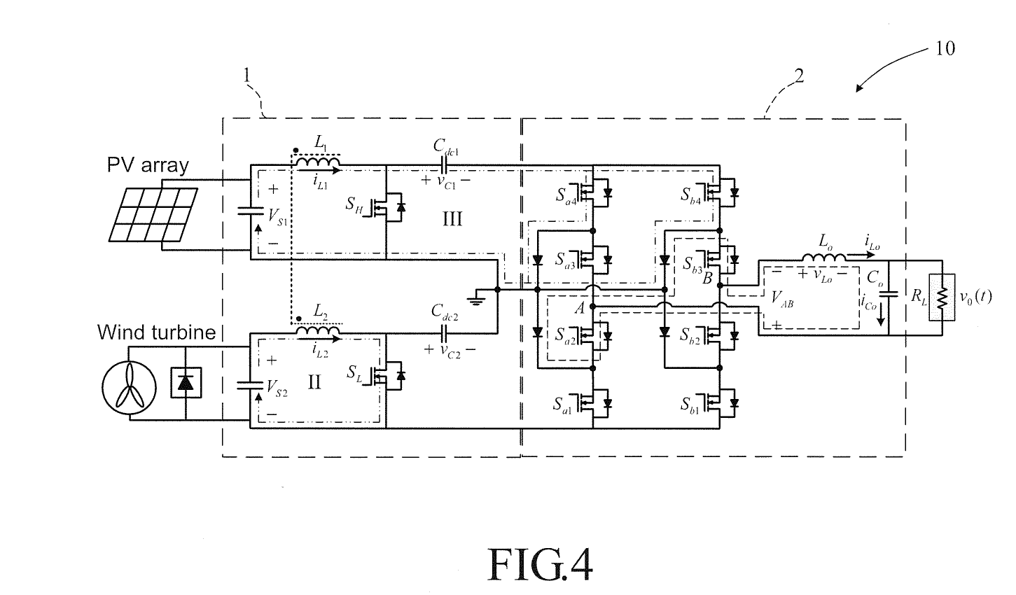

Referring to FIGS. 2 and 4, when the controller 20 controls the first power switch S_{H} not to conduct and the second power switch S_{L} to conduct, the second variable power source V_{S2} and the second inductor L₂ still form the second loop II, i.e., the second inductor L₂ continues to store energy from the second variable power source V_{S2}, and the first variable power source V_{S1}, the first inductor L₁, the first capacitor C_{dc1}, the third switch Sₐ₃, the fourth switch Sₐ₄, the seventh switch S_{b3}, and the eighth switch S_{b4} form a third loop III. The first capacitor C_{dc1} stores energy of the first variable power source V_{S1} and the first inductor L₁ by having the third switch Sₐ₃, the fourth switch Sₐ₄, the seventh switch S_{b3}, and the eighth switch S_{b4} of the inverter module 2 conduct.

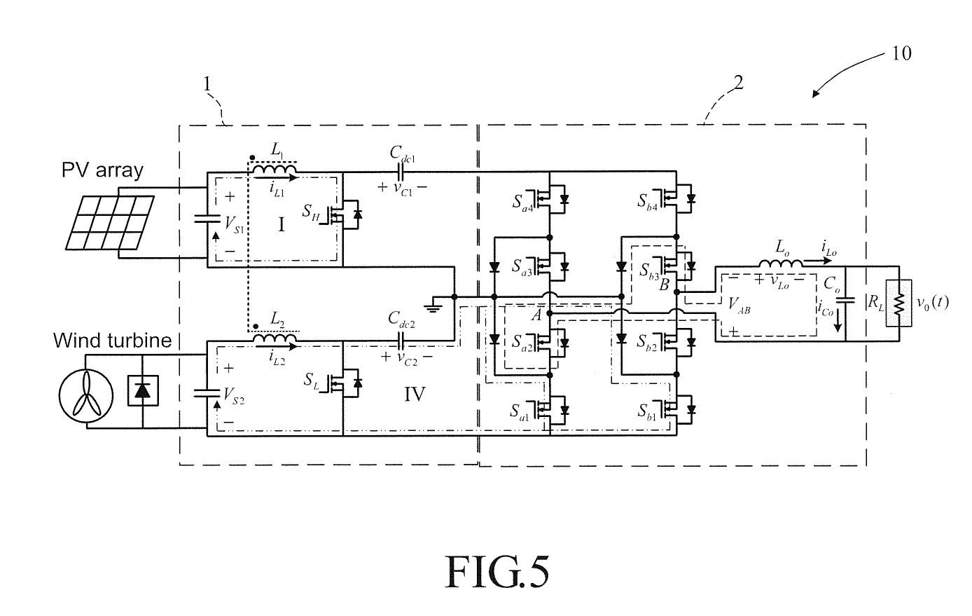

It is worth noting that to prevent the inverter module 2 from outputting AC sinusoidal waves that have unbalanced positive and negative half cycles, the first, second, fifth, and sixth switches Sₐ₁, Sₐ₂, S_{b1}, S_{b2} of the inverter module 2 are not conducting to thereby prevent the inverter module 2 from receiving energy of the second capacitor C_{dc2}. The circulating current state formed by the output inductor L_{O}, the output capacitor C_{O}, the second switch Sₐ₂, and the seventh switch S_{b3} is shown by the dotted line in FIG. 4. Referring to FIGS. 2 and 5, when the controller 20 controls the first power switch S_{H} to conduct and the second power switch S_{L} not to conduct, the first variable power source V_{S1} and the first inductor L₁ form the first loop I, i.e., the first inductor L₁ continues to store energy from the first variable power source V_{S1}, and the second variable power source V_{S2}, the second inductor L₂, the second capacitor C_{dc2}, the first switch Sₐ₁, the second switch Sₐ₂, the fifth switch S_{b1}, and the sixth switch S_{b2} form a fourth loop IV. The second capacitor C_{dc2} stores energy of the second variable power source V_{S2} and the second inductor L₂ by having the first switch Sₐ₁, the second switch Sₐ₂, the fifth switch S_{b1}, and the sixth switch S_{b2} of the inverter module 2 conduct.

Likewise, to prevent the inverter module 2 from outputting AC sinusoidal waves that have unbalanced positive and negative half cycles, the third, fourth, seventh, and eighth switches Sₐ₃, Sₐ₄, S_{b3}, S_{b4} of the inverter module 2 are not conducting to thereby prevent the inverter module 2 from receiving energy of the first capacitor C_{dc1}. The circulating current state formed by the output inductor L_{O}, the output capacitor C_{O}, the second switch Sₐ₂, and the seventh switch S_{b3} is shown by the dotted line in FIG. 5.

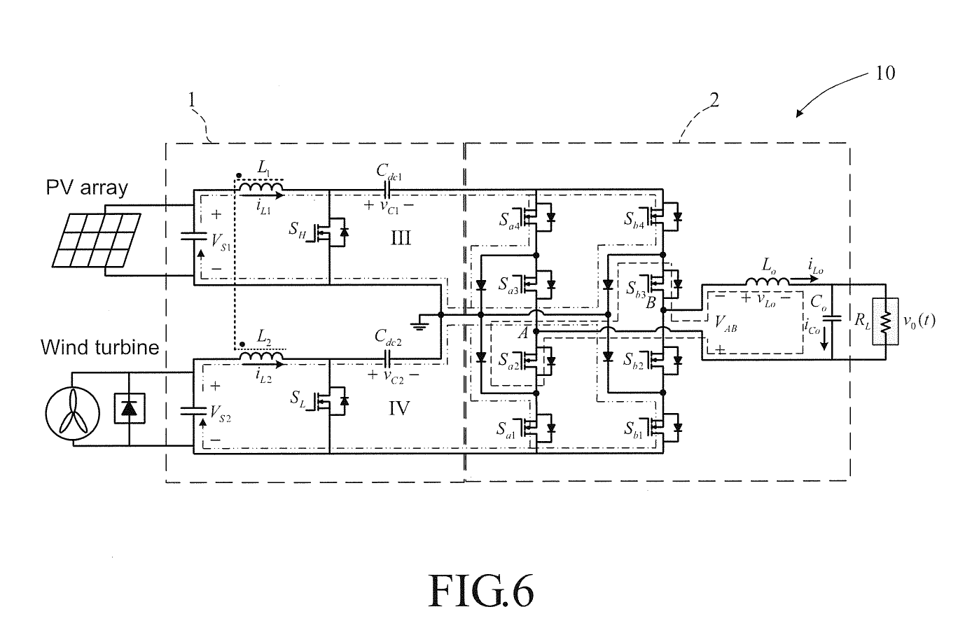

Referring to FIGS. 2 and 6, when the controller 20 controls both the first and second power switches S_{H}, S_{L} to not conduct, all the switches in the inverter module 2 are caused to conduct. The first capacitor C_{dc1} stores energy of the first variable power source V_{S1} and the first inductor L₁, and the second capacitor C_{dc2} stores energy of the second variable power source V_{S2} and the second inductor L₂. The circulating current state formed by the output inductor L_{O}, the output capacitor C_{O}, the second switch Sₐ₂ and the seventh switch S_{b3} still exists.

In sum, only when both the first and second inductors L₁, L₂ are storing energy simultaneously can the inverter module 2 convert the energy of the first and second capacitors C_{dc1} C_{dc2} to maximise power tracking, extract maximum energy, and provide a low harmonic power output to increase the power quality given to users/clients. When only one capacitor is storing energy from the first or second variable power source V_{S1}, V_{S2}, the inverter module 2 enters the circulating current state.

The DC-to-AC converter system 100 of the present embodiment adopts integrated single-stage power conversion and structure of a single controller 20 that can largely reduce the cost in design and production. By having bidirectional power flow capability, the embodiment can provide multiple outputs when used as a rectifier. As the DC-to-AC converter circuit 10 of the present embodiment employs the step-up converter module 1 and the inverter module 2 and has a specially designed pulse-width modulation integrated into a single-stage power conversion circuit, the embodiment has characteristics of multiple inputs, DC-to-AC system integration, common power switches, step-up/step-down and low switch voltage. By having the first and second inductors L₁, L₂ of the step-up converter module 1 cooperate to form a transformer, the cost of production is further reduced by lowering the number of circuit elements used.

Referring to the input terminal DC side, the step-up converter module 1 is able to alleviate the problem of low voltage input and to lower the conducting and switching loss of the first power switch S_{H} and the second power switch S_{L} by, first, providing multiple low-voltage/high current inputs and, second, step-up the voltages of the reusable/green energy resources through switching between the first and second power switches S_{H}, S_{L}. Referring to the output terminal AC-side, the inverter module 2 adopts neutral-point clamping and each switch has low switch voltage stress. This enables the entire system to have a higher reliability and high power conversion efficiency, and to achieve low harmonic high quality electrical power by using a multi-step voltage combining method. The DC-to-AC converter circuit 10 of the present embodiment can be a single phase or a three phase DC-to-AC integrated converter circuit, and the inverter module 2 can be a full bridge cascade structure, and are not limited to the aforesaid disclosure.

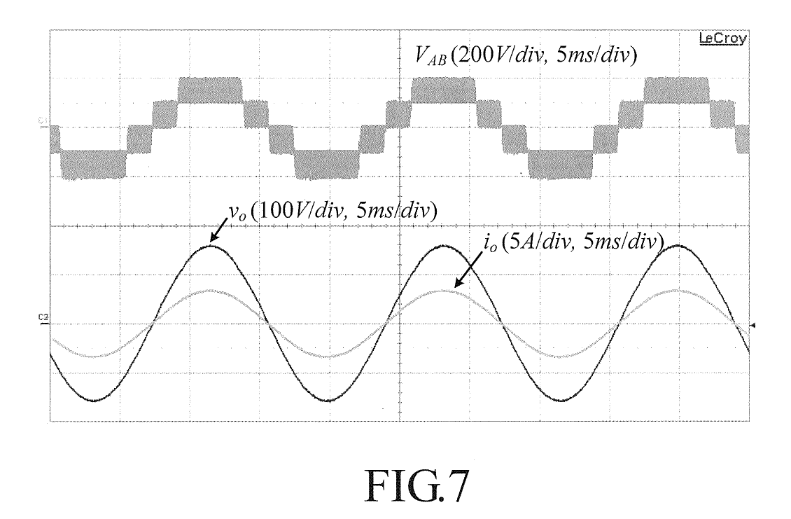

FIG. 7 shows the measured waveform diagram of the neutral-point voltage V_{AB}, the output voltage V_{O}, and the output current i_{O} of the inverter module 2, wherein the rated output power is set to be 1 kVA, first variable power source V_{S1} is set to be 36V, signal of the second variable power source V_{S2} is set to be 24V, the switching frequency is set to be 60 Hz, the first and second inductors L₁, L₂ have inductances set to be 1 mH, the first and second capacitors C_{dc1}, C_{dc2} have capacitances set to be 10 μF, the inductance of the output inductor L_{O} is set to be 1 mH, and the capacitance of the output capacitor C_{O} is set to be 10 μF. As illustrated in FIG. 7, with two different input variable power sources, the first and second capacitors C_{dc1}, C_{dc2} have, respectively, voltages of 130V and 170V, and the AC-side output neutral-point voltage V_{AB} is a four step waveform. After filtering, the effective voltage is 110V, peak value is approximately 156V, and the total harmonic distortion (THD) is less than 5%. Therefore, the DC-to-AC converter circuit 10 can adapt to multiple reusable/green energy inputs and provide high quality voltage output, thereby improving upon the shortcomings of the conventional DC-to-AC converters.

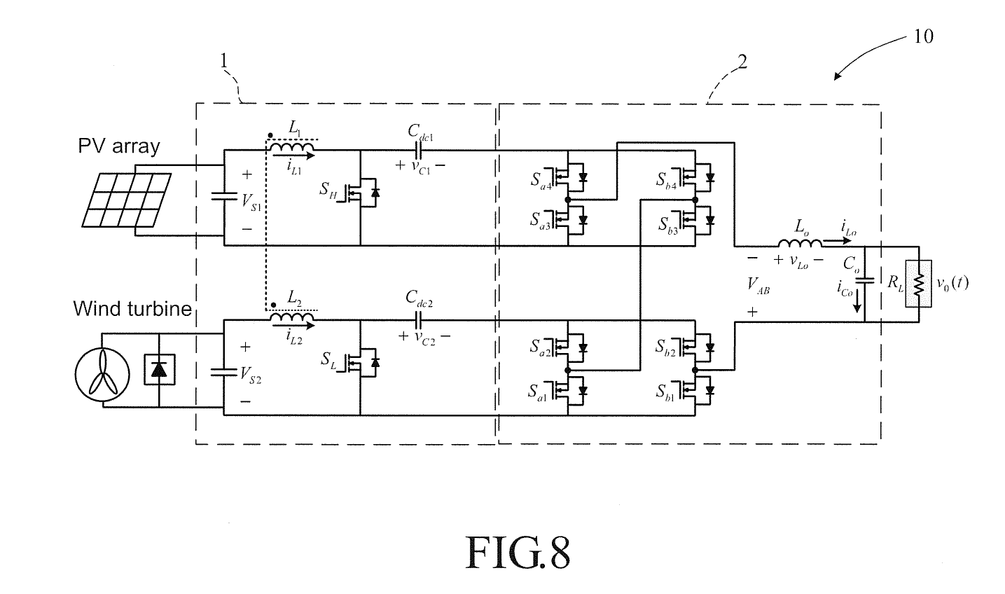

FIG. 8 illustrates the second embodiment of a DC-to-AC converter system 100 of the present invention. The difference between the first and second embodiments resides in the structure of the inverter module 2.

In this embodiment, the inverter module 2 of the DC-to-AC converter circuit 10 has a first switch Sₐ₁, a second switch Sₐ₂, a third switch Sₐ₃, a fourth switch Sₐ₄, a fifth switch S_{b1}, a sixth switch S_{b2}, a seventh switch S_{b3}, an eighth switch S_{b4}, an output inductor L_{O}, and an output capacitor C_{O}. The step-up converter module 1 is exactly the same as that of the first embodiment, and is therefore not described hereinafter.

The first switch Sₐ₁ has a drain (D) electrically coupled to the source (S) of the second switch Sₐ₂ a gate (G) electrically coupled to the controller 20 (see FIG. 1), and a source (S) electrically coupled to the source (S) of the second power switch S_{L}. The second switch Sₐ₂ has a drain (D) electrically coupled to the second terminal of the second capacitor C_{dc2}, and a gate (G) electrically coupled to the controller 20. The third switch Sₐ₃ has a drain (D) electrically coupled to a source (S) of the fourth switch Sₐ₄, a gate (G) electrically coupled to the controller 20, and a source (S) electrically coupled to the source (S) of the first power switch S_{H}. The fourth switch Sₐ₄ has a drain (D) electrically coupled to the second terminal of the first capacitor C_{dc1}, a gate (G) electrically coupled to the controller 20. The fifth switch S_{b1} has a drain (D) electrically coupled to the source (S) of the sixth switch S_{b2}, a gate (G) electrically coupled to the controller 20, and a source (S) electrically coupled to the source (S) of the second power switch S_{L}. The sixth switch S_{b2} has a drain (D) electrically coupled to the second terminal of the second capacitor C_{dc2}/and a gate (G) electrically coupled to the controller 20. The seventh switch S_{b3} has a drain (D) electrically coupled to the source (S) of the eighth switch S_{b4}, a gate (G) electrically coupled to the controller 20, and a source (S) electrically coupled to the source of the first power switch S_{H}. The eighth switch S_{b4} has a drain (D) electrically coupled to the second terminal of the first capacitor C_{dc1}, and a gate (G) electrically coupled to the controller 20. The drain (D) of the first switch S₁ is electrically coupled to the drain (D) of the seventh switch S_{b3}.

The output inductor L_{O} has a first terminal electrically coupled to the drain (D) of the third switch Sₐ₃, and a second terminal electrically coupled to a first terminal of the output capacitor C_{O} and the load R_{L}. A second terminal of the output capacitor C_{O} is electrically coupled to the drain (D) of the fifth switch S_{b1}. The DC-to-AC converter circuit 10 of this embodiment also achieves the objects of reducing cost, increasing reliability and increasing power conversion efficiency.

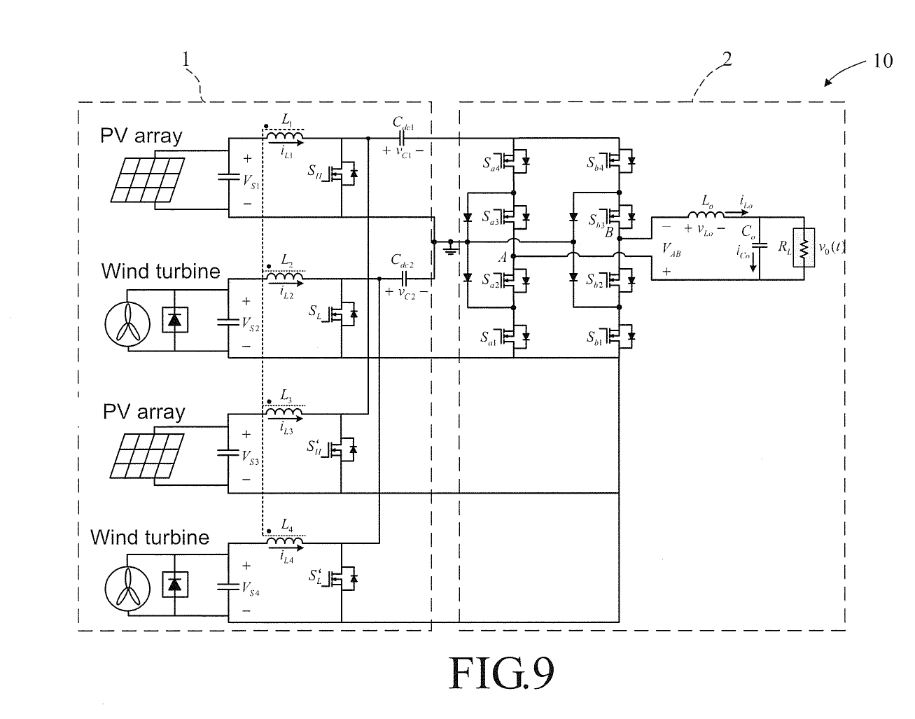

FIG. 9 illustrates the third embodiment of the DC-to-AC converter system 100 of the present invention. The difference resides in that the step-up converter module 1 further includes a third inductor L₃, a fourth inductor L₄, a third power switch S_{H}′, and a fourth power switch S_{L}′. The step-up converter module 1 of the present embodiment includes four step-up converter units (wherein the third inductor L₃ and the third power switch S_{H}′ form a step-up converter unit, and the fourth inductor L₄ and the fourth power switch S_{L}′ form another step-up converter unit), but the number of step-up converter units is not limited to the aforesaid disclosure.

The third inductor L₃ has a first terminal for receiving signal of a third variable power source V_{S3}. The third power switch S_{H}′ is an N-type metal oxide semiconductor-field effect transistor having a drain (D) to be electrically coupled to the second terminal of the third inductor L₃ and the first terminal of the first capacitor C_{dc1}, a gate (G) electrically coupled to the controller 20, and a source (S) electrically coupled to the source (S) of the first power switch S_{H}. The controller 20 controls the third power switch S_{H}′ to be in the conducting state (ON) or the non-conducting state (OFF). The fourth inductor L₄ has a first terminal for receiving a fourth variable power source V_{S4}. The fourth power switch S_{L}′ is an N-type metal oxide semiconductor-field effect transistor having a drain (D) electrically coupled to a second terminal of the fourth inductor L₄ and the first terminal of the second capacitor C_{dc2}, a gate (G) electrically coupled to the controller 20, and a source (S) electrically coupled to the source (S) of the second power switch S_{L}. The controller 20 controls the fourth power switch S_{L}′ to be in the conducting state (ON) or the non-conducting state (OFF). The first to fourth inductors L₁-L₄ cooperate to form a transformer. In the present embodiment, PV array is used here as the example of the third variable power source V. Wind turbine is used here as the example of the fourth variable power source V_{S4}. The switching frequencies of the first and third power switches S_{H}, S_{H}′ are identical, and the switching frequencies of the second and fourth power switches S_{L}, S_{L}′ are identical.

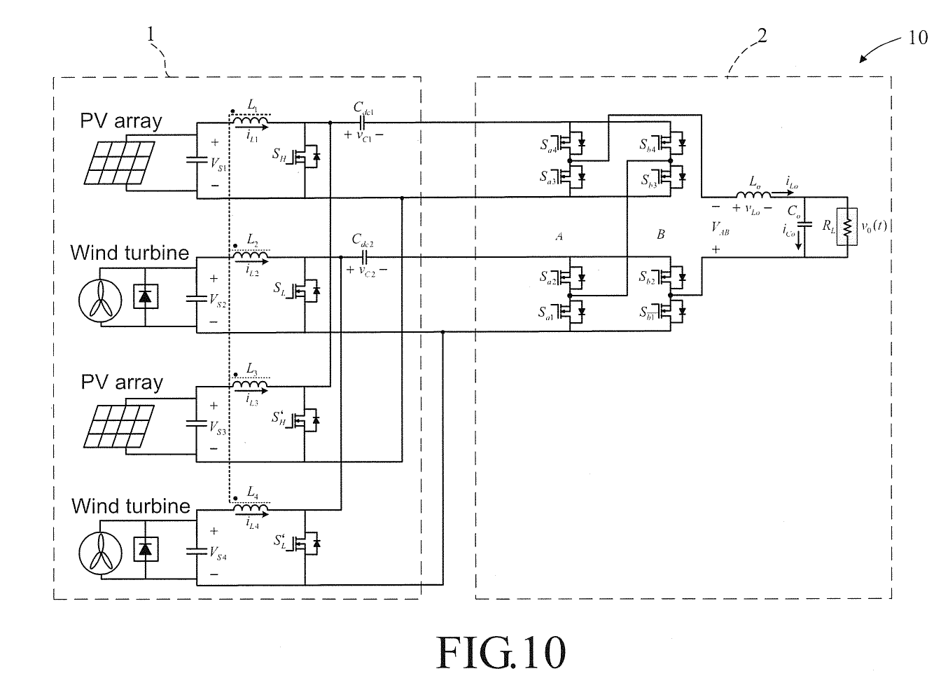

When the controller 20 controls all the power switches S_{H}, S_{L}, S_{H}′ S_{L}′ to conduct, the first to fourth inductors L₁-L₄ store energy of the first to fourth variable power sources V_{S1}-V_{S4} respectively, and the first capacitor C_{dc1} and the second capacitor C_{dc2} are series-connected to provide additive electrical energy stored by all inductors to the inverter module 2, extracting the greatest power. When the controller 20 controls the first and third power switches S_{H}, S_{H}′ not to conduct, the first capacitor C_{dc1} stores energy of the first and third variable power sources V_{S1}, V_{S3} and the first and third inductors L₁, L₃, and the inverter module 2 will enter the circulating current mode. When the controller 20 controls the second and fourth power switches S_{L}, S_{L}′ not to conduct, the second capacitor C_{dc2} stores energy of the second and fourth variable power sources V_{S2}, V_{S4} and the second and fourth inductors L₂, L₄, and the inverter module 2 will enter the circulating current mode. In other words, whenever a variable power source releases energy to the corresponding capacitor, the inverter module 2 will enter the circulating current mode. The DC-to-AC converter circuit 10 of this embodiment also has characteristics of multiple inputs, DC-to-AC system integration, shared power switches, step-up/step-down and low switch voltage, moreover, with four step-up converter units sharing the first and second capacitors C_{dc1}, C_{dc2}, reduced cost, increased reliability and increased power conversion efficiency are achieved. The structure of the inverter module 2 can be arranged to be that of the second embodiment of the present invention, as shown in FIG. 10, while achieving the same objects of this invention.

As described above, the DC-to-AC converter system 100 of the present invention uses the step-up converter module 1 and the inverter module 2, and uses the controller 20 to control the conduction and non-conduction of the power switches and switches to have multiple inputs, DC-to-AC system integration, shared power switches, step-up/step-down and low switch voltage characteristics. On top of that, inside the step-up converter module 1, the design of the first inductor L₁ cooperating with the second inductor L₂ to form a transformer, and the third inductor L₃ cooperating with the fourth inductor L₄ to form a transformer, and multiple step-up converter units sharing the first and second capacitors C_{dc1}, C_{dc2}, the number of the components used can be reduced, thereby reducing cost.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A DC-to-AC converter circuit comprising:
a step-up converter module including
a first inductor having a first terminal for receiving signal of a first variable power source, and a second terminal,
a first power switch electrically coupled to said second terminal of said first inductor,
a first capacitor having a first terminal electrically coupled to said second terminal of said first inductor, and a second terminal,
a second inductor cooperating with said first inductor to form a transformer, said second inductor having a first terminal for receiving signal of a second variable power source, and a second terminal,
a second power switch electrically coupled to said second terminal of said second inductor, and
a second capacitor having a first terminal electrically coupled to said second terminal of said second inductor, and a second terminal; and
an inverter module electrically coupled to said second terminal of said first capacitor and said second terminal of said second capacitor;
wherein when said first power switch and said second power switch conduct, said first inductor and said second inductor store energy from the first variable power source and the second variable power source respectively, and after said first capacitor and said second capacitor provide electrical energy to said inverter module, said inverter module converts the electrical energy provided thereto and outputs converted energy,
wherein when said first power switch is not conducting, said first capacitor receives energy from the first variable power source and said first inductor, and when said second power switch is not conducting, said second capacitor receives energy from the second variable power source and said second inductor.

2. The DC-to-AC converter circuit as claimed in claim 1, wherein said step-up converter module further includes:
a third inductor having a first terminal for receiving signal of a third variable power source, and a second terminal;
a third power switch electrically coupled to said second terminal of said third inductor and said first terminal of said first capacitor;
a fourth inductor having a first terminal for receiving signal of a fourth variable power source, and a second terminal, wherein said first inductor, said second inductor, said third inductor and said fourth inductor cooperate to form a transformer; and
a fourth power switch electrically coupled to said second terminal of said fourth inductor and said first terminal of said second capacitor;
wherein when said third and fourth power switches conduct, said third inductor and said fourth inductor store energy from the third variable power source and the fourth variable power source respectively, and after said first capacitor and said second capacitor provide electrical energy to said inverter module, said inverter module converts the electrical energy provided thereto and outputs converted energy,
wherein when said third power switch is not conducting, said first capacitor receives electrical energy from the third variable power source and said third inductor, and when said fourth power switch is not conducting, said second capacitor receives electrical energy from the fourth variable power source and said fourth inductor.

3. The DC-to-AC converter circuit as claimed in claim 2, wherein:
said first power switch includes a drain electrically coupled to said second terminal of said first inductor, a gate for controlling conduction and non-conduction of said first power switch, and a source electrically coupled to said second terminal of said second capacitor; and
said second power switch includes a drain electrically coupled to said second terminal of said second inductor, a gate for controlling conduction and non-conduction of said second power switch, and a source electrically coupled to said inverter module.

4. The DC-to-AC converter circuit as claimed in claim 3, wherein said inverter module includes:
a first switch having a drain, a gate for controlling conduction and non-conduction of said first switch, and a source electrically coupled to said source of said second power switch;
a second switch having a drain, a gate for controlling conduction and non-conduction of said second switch, and a source electrically coupled to said drain of said first switch;
a third switch having a drain, a gate for controlling conduction and non-conduction of said third switch, and a source electrically coupled to said drain of said second switch;
a fourth switch having a drain electrically coupled to said second terminal of said first capacitor, a gate for controlling conduction and non-conduction of said fourth switch, and a source electrically coupled to said drain of said third switch;
a fifth switch having a drain, a gate for controlling conduction and non-conduction of said fifth switch, and a source electrically coupled to said source of said second power switch;
a sixth switch having a drain, a gate for controlling conduction and non-conduction of said sixth switch, and a source electrically coupled to said drain of said fifth switch;
a seventh switch having a drain, a gate for controlling conduction and non-conduction of said seventh switch, and a source electrically coupled to said drain of said sixth switch;
an eighth switch having a drain electrically coupled to said second terminal of said first capacitor, a gate for controlling conduction and non-conduction of said eighth switch, and a source electrically coupled to said drain of said seventh switch, wherein said source of said first power switch, said second terminal of said second capacitor, said drain of said first switch, said drain of said third switch, said drain of said fifth switch, and said drain of said seventh switch are electrically coupled to ground;
an output inductor having a first terminal electrically coupled to said drain of said sixth switch, and a second terminal; and
an output capacitor having a first terminal electrically coupled to said second terminal of said output inductor, and a second terminal electrically coupled to said drain of said second switch.

5. The DC-to-AC converter circuit as claimed in claim 3, wherein said inverter module includes:
a first switch having a drain, a gate for controlling conduction and non-conduction of said first switch, and a source electrically coupled to said source of said second power switch;
a second switch having a drain electrically coupled to said second terminal of said second capacitor, a gate for controlling conduction and non-conduction of said second switch, and a source electrically coupled to said drain of said first switch;
a third switch having a drain, a gate for controlling conduction and non-conduction of said third switch, and a source electrically coupled to said source of said first power switch;
a fourth switch having a drain electrically coupled to said second terminal of said first capacitor, a gate for controlling conduction and non-conduction of said fourth switch, and a source electrically coupled to said drain of said third switch;
a fifth switch having a drain, a gate for controlling conduction and non-conduction of said fifth switch, and a source electrically coupled to said source of said second power switch;
a sixth switch having a drain electrically coupled to said second terminal of said second capacitor, a gate for controlling conduction and non-conduction of said sixth switch, and a source electrically coupled to said drain of said fifth switch;
a seventh switch having a drain electrically coupled to said drain of said first switch, a gate for controlling conduction and non-conduction of said seventh switch, and a source electrically coupled to said source of said first power switch;
an eighth switch having a drain electrically coupled to said second terminal of said first capacitor, a gate for controlling conduction and non-conduction of said eighth switch, and a source electrically coupled to said drain of said seventh switch;
an output inductor having a first terminal electrically coupled to said drain of said third switch, and a second terminal; and
an output capacitor having a first terminal electrically coupled to said second terminal of said output inductor, and a second terminal electrically coupled to said drain of said fifth switch.

6. The DC-to-AC converter circuit as claimed in claim 1, wherein:
said first power switch includes a drain electrically coupled to said second terminal of said first inductor, a gate for controlling conduction and non-conduction of said first power switch, and a source electrically coupled to said second terminal of said second capacitor; and
said second power switch includes a drain electrically coupled to said second terminal of said second inductor, a gate for controlling conduction and non-conduction of said second power switch, and a source electrically coupled to said inverter module.

7. The DC-to-AC converter circuit as claimed in claim 6, wherein said inverter module includes:
a first switch having a drain, a gate for controlling conduction and non-conduction of said first switch, and a source electrically coupled to said source of said second power switch;
a second switch having a drain, a gate for controlling conduction and non-conduction of said second switch, and a source electrically coupled to said drain of said first switch;
a third switch having a drain, a gate for controlling conduction and non-conduction of said third switch, and a source electrically coupled to said drain of said second switch;
a fourth switch having a drain electrically coupled to said second terminal of said first capacitor, a gate for controlling conduction and non-conduction of said fourth switch, and a source electrically coupled to said drain of said third switch;
a fifth switch having a drain, a gate for controlling conduction and non-conduction of said fifth switch, and a source electrically coupled to said source of said second power switch;
a sixth switch having a drain, a gate for controlling conduction and non-conduction of said sixth switch, and a source electrically coupled to said drain of said fifth switch;
a seventh switch having a drain, a gate for controlling conduction and non-conduction of said seventh switch, and a source electrically coupled to said drain of said sixth switch;
an eighth switch having a drain electrically coupled to said second terminal of said first capacitor, a gate for controlling conduction and non-conduction of said eighth switch, and a source electrically coupled to said drain of said seventh switch, wherein said source of said first power switch, said second terminal of said second capacitor, said drain of said first switch, said drain of said third switch, said drain of said fifth switch, and said drain of said seventh switch are electrically coupled to ground;
an output inductor having a first terminal electrically coupled to said drain of said sixth switch, and a second terminal; and
an output capacitor having a first terminal electrically coupled to said second terminal of said output inductor, and a second terminal electrically coupled to said drain of said second switch.

8. The DC-to-AC converter circuit as claimed in claim 6, wherein said inverter module includes:
a first switch having a drain, a gate for controlling conduction and non-conduction of said first switch, and a source electrically coupled to said source of said second power switch;
a second switch having a drain electrically coupled to said second terminal of said second capacitor, a gate for controlling conduction and non-conduction of said second switch, and a source electrically coupled to said drain of said first switch;
a third switch having a drain, a gate for controlling conduction and non-conduction of said third switch, and a source electrically coupled to said source of said first power switch;
a fourth switch having a drain electrically coupled to said second terminal of said first capacitor, a gate for controlling conduction and non-conduction of said fourth switch, and a source electrically coupled to said drain of said third switch;
a fifth switch having a drain, a gate for controlling conduction and non-conduction of said fifth switch, and a source electrically coupled to said source of said second power switch;
a sixth switch having a drain electrically coupled to said second terminal of said second capacitor, a gate for controlling conduction and non-conduction of said sixth switch, and a source electrically coupled to said drain of said fifth switch;
a seventh switch having a drain electrically coupled to said drain of said first switch, a gate for controlling conduction and non-conduction of said seventh switch, and a source electrically coupled to said source of said first power switch;
an eighth switch having a drain electrically coupled to said second terminal of said first capacitor, a gate for controlling conduction and non-conduction of said eighth switch, and a source electrically coupled to said drain of said seventh switch;
an output inductor having a first terminal electrically coupled to said drain of said third switch, and a second terminal; and
an output capacitor having a first terminal electrically coupled to said second terminal of said output inductor, and a second terminal electrically coupled to said drain of said fifth switch.

9. A DC-to-AC converter system comprising:
a controller; and
a DC-to-AC converter circuit including
a step-up converter module including
a first inductor having a first terminal for receiving signal of a first variable power source, and a second terminal,
a first power switch electrically coupled to said second terminal of said first inductor and controlled by said controller to conduct or not conduct,
a first capacitor having a first terminal electrically coupled to said second terminal of said first inductor, and a second terminal,
a second inductor cooperating with said first inductor to form a transformer, said second inductor having a first terminal for receiving signal of a second variable power source, and a second terminal,
a second power switch electrically coupled to said second terminal of said second inductor and controlled by said controller to conduct or not conduct, and
a second capacitor having a first terminal electrically coupled to said second terminal of said second inductor, and a second terminal; and
an inverter module electrically coupled to said second terminal of said first capacitor and said second terminal of said second capacitor;
wherein when said first power switch and said second power switch conduct, said first inductor and said second inductor store energy from the first variable power source and the second variable power source respectively, and after said first capacitor and said second capacitor provide electrical energy to said inverter module, said inverter module converts the electrical energy provided thereto and outputs converted energy;
wherein when said first power switch is not conducting, said first capacitor receives energy from the first variable power source and said first inductor, and when said second power switch is not conducting, said second capacitor receives energy from the second variable power source and said second inductor.

10. The DC-to-AC converter system as claimed in claim 9, wherein said step-up converter module further includes:
a third inductor having a first terminal for receiving signal of a third variable power source signal, and a second terminal;
a third power switch electrically coupled to said second terminal of said third inductor and said first terminal of said first capacitor and controlled by said controller to conduct or not conduct;
a fourth inductor having a first terminal for receiving signal of a fourth variable power source signal, and a second terminal, wherein said first inductor, said second inductor, said third inductor and said fourth inductor cooperate to form a transformer; and
a fourth power switch electrically coupled to said second terminal of said fourth inductor and said first terminal of said second capacitor and controlled by said controller to conduct or not conduct;
wherein when said third and fourth power switches conduct, said third inductor and said fourth inductor store energy from the third variable power source and the fourth variable power source respectively, and after said first capacitor and said second capacitor provide electrical energy to said inverter module, said inverter module converts the electrical energy provided thereto and outputs converted energy;
wherein when said third power switch is not conducting, said first capacitor receives electrical energy from the third variable power source and said third inductor, and when said fourth power switch is not conducting, said second capacitor receives electrical energy from the fourth variable power source and said fourth inductor.

11. The DC-to-AC converter system as claimed in claim 10, wherein:
said first power switch includes a drain electrically coupled to said second terminal of said first inductor, a gate electrically coupled to said controller, and a source electrically coupled to said second terminal of said second capacitor; and
said second power switch includes a drain electrically coupled to said second terminal of said second inductor, a gate electrically coupled to said controller, and a source electrically coupled to said inverter module.

12. The DC-to-AC converter system as claimed in claim 11, wherein said inverter module includes:
a first switch having a drain, a gate electrically coupled to said controller, and a source electrically coupled to said source of said second power switch;
a second switch having a drain, a gate electrically coupled to said controller, and a source electrically coupled to said drain of said first switch;
a third switch having a drain, a gate electrically coupled to said controller, and a source electrically coupled to said drain of said second switch;
a fourth switch having a drain electrically coupled to said second terminal of said first capacitor, a gate electrically coupled to said controller, and a source electrically coupled to said drain of said third switch;
a fifth switch having a drain, a gate electrically coupled to said controller, and a source electrically coupled to said source of said second power switch;
a sixth switch having a drain, a gate electrically coupled to said controller, and a source electrically coupled to said drain of said fifth switch;
a seventh switch having a drain, a gate electrically coupled to said controller, and a source electrically coupled to said drain of said sixth switch;
an eighth switch having a drain electrically coupled to said second terminal of said first capacitor, a gate electrically coupled to said controller, and a source electrically coupled to said drain of said seventh switch, wherein said source of said first power switch, said second terminal of said second capacitor, said drain of said first switch, said drain of said third switch, said drain of said fifth switch, and said drain of said seventh switch are electrically coupled to ground;
an output inductor having a first terminal electrically coupled to said drain of said sixth switch, and a second terminal; and
an output capacitor having a first terminal electrically coupled to said second terminal of said output inductor, and a second terminal electrically coupled to said drain of said second switch.

13. The DC-to-AC converter system as claimed in claim 11, wherein said inverter module includes:
a first switch having a drain, a gate electrically coupled to said controller, and a source electrically coupled to said source of said second power switch;
a second switch having a drain electrically coupled to said second terminal of said second capacitor, a gate electrically coupled to said controller, and a source electrically coupled to said drain of said first switch;
a third switch having a drain, a gate electrically coupled to said controller, and a source electrically coupled to said source of said first power switch;
a fourth switch having a drain electrically coupled to said second terminal of said first capacitor, a gate electrically coupled to said controller, and a source electrically coupled to said drain of said third switch;
a fifth switch having a drain, a gate electrically coupled to said controller, and a source electrically coupled to said source of said second power switch;
a sixth switch having a drain electrically coupled to said second terminal of said second capacitor, a gate electrically coupled to said controller, and a source electrically coupled to said drain of said fifth switch;
a seventh switch having a drain electrically coupled to said drain of said first switch, a gate electrically coupled to said controller, and a source electrically coupled to said source of said first power switch;
an eighth switch having a drain electrically coupled to said second terminal of said first capacitor, agate electrically coupled to said controller, and a source electrically coupled to said drain of said seventh switch;
an output inductor having a first terminal electrically coupled to said drain of said third switch, and a second terminal; and
an output capacitor having a first terminal electrically coupled to said second terminal of said output inductor, and a second terminal electrically coupled to said drain of said fifth switch.

14. The DC-to-AC converter system as claimed in claim 9, wherein:
said first power switch includes a drain electrically coupled to said second terminal of said first inductor, a gate electrically coupled to said controller, and a source electrically coupled to said second terminal of said second capacitor; and
said second power switch includes a drain electrically coupled to said second terminal of said second inductor, a gate electrically coupled to said controller, and a source electrically coupled to said inverter module.

15. The DC-to-AC converter system as claimed in claim 14, wherein said inverter module includes:
a first switch having a drain, a gate electrically coupled to said controller, and a source electrically coupled to said source of said second power switch;
a second switch having a drain, a gate electrically coupled to said controller, and a source electrically coupled to said drain of said first switch;
a third switch having a drain, a gate electrically coupled to said controller, and a source electrically coupled to said drain of said second switch;
a fourth switch having a drain electrically coupled to said second terminal of said first capacitor, a gate electrically coupled to said controller, and a source electrically coupled to said drain of said third switch;
a fifth switch having a drain, a gate electrically coupled to said controller, and a source electrically coupled to said source of said second power switch;
a sixth switch having a drain, a gate electrically coupled to said controller, and a source electrically coupled to said drain of said fifth switch;
a seventh switch having a drain, a gate electrically coupled to said controller, and a source electrically coupled to said drain of said sixth switch;
an eighth switch having a drain electrically coupled to said second terminal of said first capacitor, a gate electrically coupled to said controller, and a source electrically coupled to said drain of said seventh switch, wherein said source of said first power switch, said second terminal of said second capacitor, said drain of said first switch, said drain of said third switch, said drain of said fifth switch, and said drain of said seventh switch are electrically coupled to ground;
an output inductor having a first terminal electrically coupled to said drain of said sixth switch, and a second terminal; and
an output capacitor having a first terminal electrically coupled to said second terminal of said output inductor, and a second terminal electrically coupled to said drain of said second switch.

16. The DC-to-AC converter system as claimed in claim 14, wherein said inverter module includes:
a first switch having a drain, a gate electrically coupled to said controller, and a source electrically coupled to said source of said second power switch;
a second switch having a drain electrically coupled to said second terminal of said second capacitor, a gate electrically coupled to said controller, and a source electrically coupled to said drain of said first switch;
a third switch having a drain, a gate electrically coupled to said controller, and a source electrically coupled to said source of said first power switch;
a fourth switch having a drain electrically coupled to said second terminal of said first capacitor, a gate electrically coupled to said controller, and a source electrically coupled to said drain of said third switch;
a fifth switch having a drain, a gate electrically coupled to said controller, and a source electrically coupled to said source of said second power switch;
a sixth switch having a drain electrically coupled to said second terminal of said second capacitor, a gate electrically coupled to said controller, and a source electrically coupled to said drain of said fifth switch;
a seventh switch having a drain electrically coupled to said drain of said first switch, a gate electrically coupled to said controller, and a source electrically coupled to said source of said first power switch;
an eighth switch having a drain electrically coupled to said second terminal of said first capacitor, a gate electrically coupled to said controller, and a source electrically coupled to said drain of said seventh switch;
an output inductor having a first terminal electrically coupled to said drain of said third switch, and a second terminal; and
an output capacitor having a first terminal electrically coupled to said second terminal of said output inductor, and a second terminal electrically coupled to said drain of said fifth switch.
